(19) United States
(12) Patent Application Publication
(10) Pub. No.: US 2004/0203927 A1
(43) Pub. Date: Oct. 14, 2004

(54) Cellular telephone location service

(76) Inventor: Clifford H. Kraft, Naperville, IL (US)

Correspondence Address: Clifford Kraft, 320 Robin Hill Dr., Naperville, IL, 60540, US

(21) Appl. No.: 10/632,406

(22) Filed: Aug. 1, 2003

Related U.S. Application Data
(60) Provisional application No. 60/461,930, filed on Apr. 10, 2003.

(51) Int. Cl. H04Q 7/20

(52) U.S. Cl. 455/456.2; 455/456.1; 455/457

(57) ABSTRACT

A telephone location system where a consumer can ask a service bureau to find the location of a particular mobile telephone possibly for a fee. The service bureau contacts the correct mobile service provider who locates the mobile telephone if possible using assisted GPS or any other location method and returns the location to the service bureau possibly for an access charge. The service bureau can return the telephone location to the consumer in a relational form or in terms of absolute coordinates (such as longitude and latitude). A total or partial privacy feature allows the mobile telephone to turn-off location to all but emergency services or people possessing an identification such as a PIN.

This application is related to and claims priority from U.S. Provisional patent application number 60/461,930 filed Apr. 10, 2003 and hereby incorporates that application by reference.

### BACKGROUND

1. Field of the Invention

The present invention relates generally to the field of cellular telephony and more particularly to a location service where subscribers can locate a particular cellular telephone on demand.

2. Description of the Prior Art

It is known in the art of cellular telephony to use assisted GPS location and other location techniques such as distance from a base station tower and triangularization for emergency location of the handset by emergency personnel such as in the case of a 911 call. In assisted GPS, the cellular handset is sent a set of parameters by the service provider that allows the handset to quickly lock onto enough satellites, even in poor signal conditions, to allow the handset to send a set of pseudo-ranges or other data back to a location facility at the service provider. The location facility has additional satellite data such as ephemeris data which relates to the satellite's position. The location facility can then locate the handset to within about 10 meters or better and send that information to emergency personnel or to an emergency 911 reception center.

Other inferior techniques exist in competition with assisted GPS including triangulation from base-station towers and raw distance from the nearest base station. While these other methods can work, there are two reasons assisted GPS will most probably be the universal service: 1) it simply works better, and 2) all cellphones being sold now in the US are required to have the capability by law.

The emergency location schemes allow an emergency service such as E911 to immediately locate a cellular telephone placing a 911 call. However, the information is only available to emergency personnel and is only initiated upon receipt of an emergency order at the particular provider's service center. Since there are multiple cellular telephone providers using different technologies, it is difficult to coordinate exactly which provider the telephone belongs to. What is badly needed is a service that would be available to a consumer that would locate a cellular telephone no matter which provider was providing the service and provide that data to the consumer in a meaningful form. Privacy concerns should also be respected by such a service.

### SUMMARY OF THE INVENTION

The present invention relates to a telephone location system that can include an assisted GPS telephone handset and a telephone service provider providing assisted GPS telephone location services in communication with the handset. A consumer location service facility can accept a request from a consumer to locate a particular cellular handset. This consumer location service facility can then cooperate with the telephone service provider to determine a telephone handset location of the particular telephone handset. The consumer location service facility can then communicate the telephone handset location to the consumer in a form meaningful to the consumer.

### DESCRIPTION OF THE DRAWINGS

FIG. 1 shows a block diagram of a locator service in an assisted GPS system.

FIG. 2 shows details of a universal locator center.

FIG. 3 shows general message and call flow.

FIG. 4 shows a representative flow-chart of conversion of position to relational form.

### DESCRIPTION OF THE INVENTION

The present invention relates to a telephone location system that can include an assisted GPS telephone handset, a telephone service provider that provides assisted GPS telephone location services in communication with the handset, and a consumer location service facility that accepts requests from a consumers to locate particular cellular handsets. The consumer location service facility can cooperate with the telephone service provider to determine a telephone handset location of a particular telephone handset with the consumer location service facility then communicating the telephone handset location back to the consumer. Usually this would be as a longitude and latitude of the handset; however, it could be in relational also such as a street intersection or in any other form.

Other handset location techniques can also be used such as triangularization, and distance from base-station towers.

The telephone handset location can be returned to the consumer by verbal description, by means of a map or by any relational type of location such as a street intersection. The service could be provided by placing a telephone call from any telephone or from an internet webpage.

The telephone handset location can be blocked by an action of an owner of said telephone handset to achieve privacy. This could be done either by a physical setting on the telephone handset or by sending a privacy request to the provider where the provider would then set the privacy mode in a manner similar to call forwarding.

The present invention provides a location method and service where a consumer can initiate a request to a central location or to a provider's location service possibly for a fee to locate a cellular telephone. An example might be a mother who desires to know her daughter's location. A simple call to a service facility that could be handled totally automatically could initiate an assisted GPS location of the handset exactly as in the case of an emergency service. The service could return the response by voice of the approximate location of the handset in a relational format that a human could relate to. For example “The telephone's location is the Haller Hall at the University of Chicago”, or “The telephone's location is the corner of Madison street and Wacker Drive in Chicago Ill.” The user could alternately ask for longitude and latitude of the handset if desired for entry into a computer map program, or this could be provided automatically through a web interface. This would be especially useful for rural locations where there are no obvious checkpoints or recognition points.

An alternate embodiment of the present invention could use internet access from a computer. In this embodiment, a user would access a provider's website or the website of a central service bureau and place the location request online. The service could locate the cellular handset and return the information on the user's computer screen in the form of written location information and/or a map showing where the telephone was located. The user could be charged a per-request fee or a monthly fee for these services.

Because privacy is important in modern society, the present invention could optionally allow the owner of the handset to turn off location capability for non-emergency situations (E911 would always be able to locate the handset). This could be done either electronically on the handset, or preferably by sending a code to the provider that location is disabled. This would be handled similarly to the way requests are handled by providers today for call forwarding, etc. In other words, a action by the owner of a telephone handset such as setting privacy mode on the telephone or setting privacy mode with the cellular provider would block the location of the handset either from being determined or from being communicated back.

An optional reduced privacy mode is also within the scope of the present invention where the telephone handset owner only allows certain others (such as spouses, relatives or certain friends) to locate the telephone in a non-emergency case. In this case, the location request would have to originate at one of the telephones belonging to people allowed to locate that telephone, or a certain password or code could be required. The telephone or the service provider could provide several modes of operation—complete privacy, reduced privacy, no privacy. It is also within the scope of the present invention to provide a secret code or PIN that could override the privacy mode (for example if a telephone owner lost a telephone with privacy mode set, it would be difficult to locate the telephone—with a PIN, the owner could turn off privacy and proceed to locate the telephone).

The present invention thus provides several additional links into a structure that will soon be in place in the US with emergency assisted GPS capable telephones and service providers (E911—Congress has required all new cellular telephones sold in the US to contain this capability and has provided dates when providers must be able to locate 911 calls).

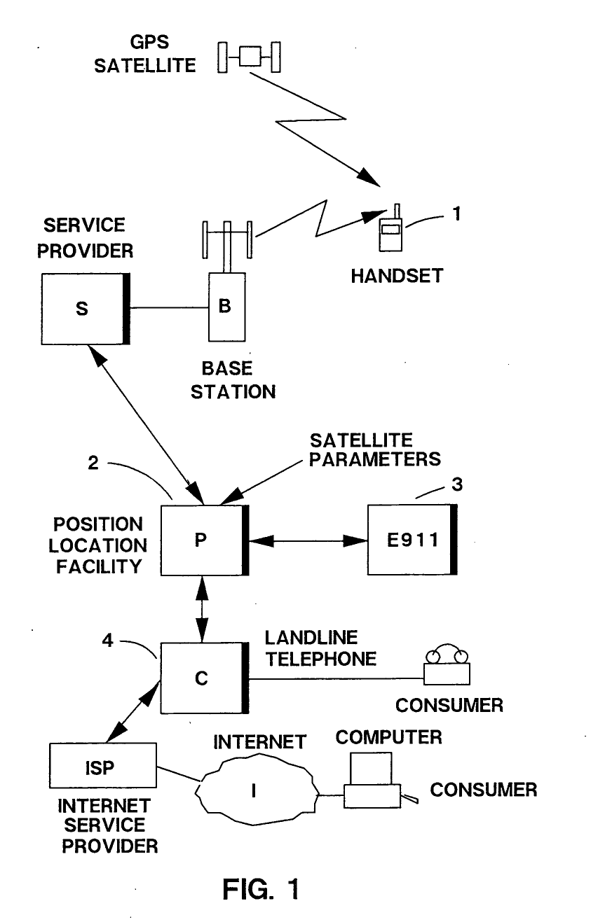

At least one of these additional links can be seen in FIG. 1 where a handset 1 contains a GPS receiver and is located by a request from a service provider's position finding facility 2 (or is located some other way). The service provider's position finding facility 2 would be in communication with an emergency 911 service 3, and would collect relevant satellite data as is known in the art of assisted GPS. The position finding facility would convert pseudo ranges into locations or position fixes and provide such locations to both the 911 service 3 and to a consumer location service 4. The consumer location service 4 could accept location requests from both the 911 service 3 and from consumers by telephone and/or internet or by any other means. In addition, the consumer location service 4 could accept requests from the same or other service providers in other cities (for example, the user who desires her daughter's location is in Chicago, and her daughter is attending an out-of-state college in California). The consumer location service 4 could also maintain records of those handsets that have turned off location (privacy mode). In the case of an attempt to locate a handset that has been set to privacy mode or cannot be located, the user might receive an error message such as “The telephone you have requested location is in privacy mode”, or the like.

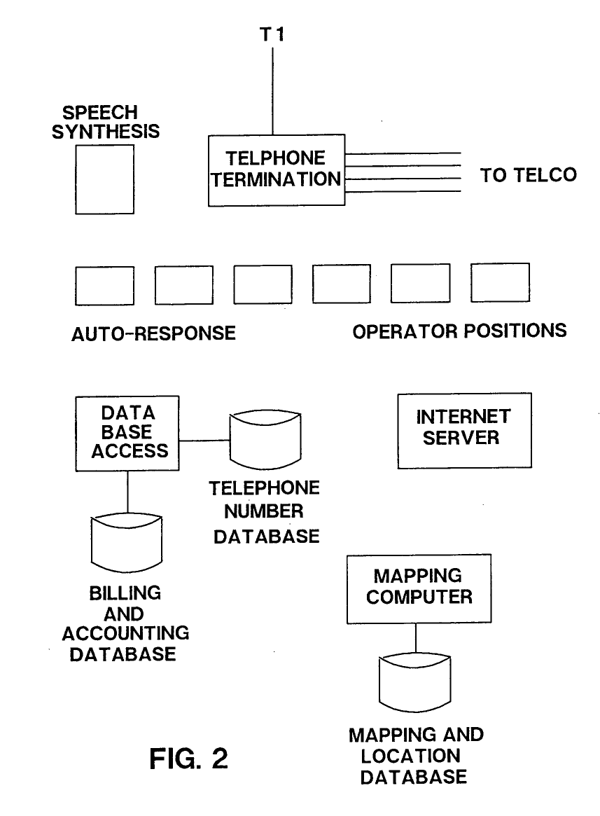

Because of the diversity of service providers and the fact that they each use somewhat different technology, a universal location service would first have to determine which provider owned a particular telephone number. Since blocks of telephone numbers in each geographic area (each area code) have been allocated to various providers in the area, and because this is public knowledge, it is a simple matter of searching database of blocks to determine which provider is servicing a particular telephone. FIG. 2 shows a typical location service (4 in FIG. 2) where telephone numbers are searched in a database so that the correct service provider can be identified.

A possible model for a location service could be a such a universal location center. The center shown in FIG. 2 would receive incoming requests for telephone location both from emergency services and from subscribers or users wishing to locate a particular telephone. Such requests could be fielded by either operator positions or an auto-response system with voice synthesis. Fees could be charged by this center for the service both general fees to emergency services or subscriptions and specific one-time fees to individuals. Such billing could be kept in a billing database as shown in FIG. 2. For example, a person desiring to locate a friend could call into the universal location service and provide the friend's cellular telephone number. The service could either charge him directly (such as with a 900 area code call), or ask for a credit card at that time.

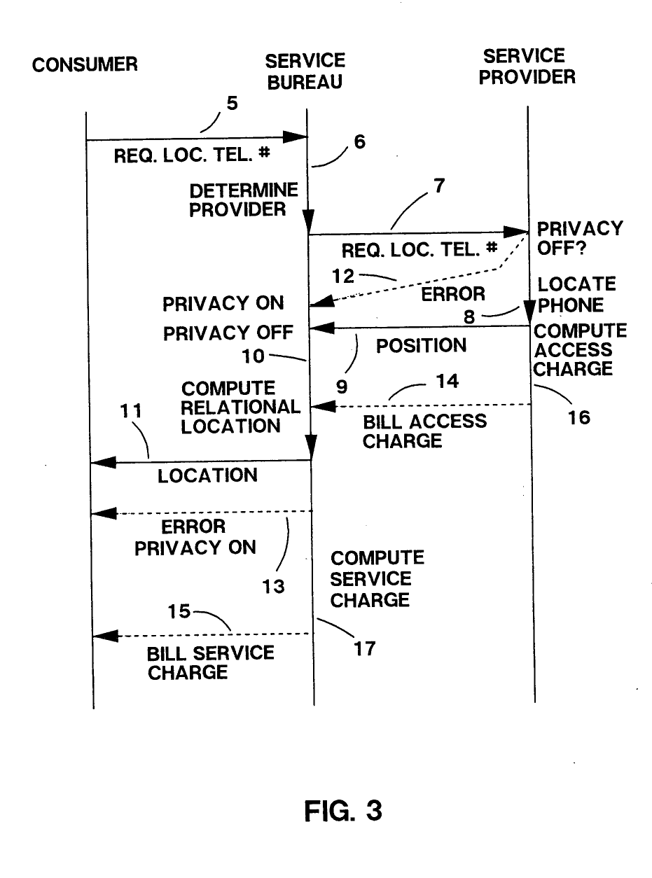

After arranging for the payment of the fee (which could also be a monthly fee charged on a billing plan by a provider), the locator service would search the database of telephone number blocks. Once the provider of the number was found (for example, AT&T, Verizon, Sprint, etc.), an electronic request could be sent to that provider's location service. The provider would go through the normal assisted GPS or other location method, and return the longitude and latitude of the telephone (or any other indication of where the phone was at that moment). The provider could then back-charge a use or access fee to the locator service. The electronic request could contain a flag showing if the request was a normal or emergency request. Emergency requests would always be answered; normal requests would be answered only if the target telephone was not set to a privacy mode (and of course turned on—although it is within the scope of the present invention for a service to electronically turn on a turned-off telephone). FIG. 3 shows possible message routing and fee charging message flow.

A location scenario starts with a consumer requesting the location of a particular mobile telephone 5. The service bureau would search a telephone number database to determine 6 which service provider is controlling the mobile telephone. A request message 7 could be dispatched to the correct service provider (Sprint PCS, Verizon, AT&T, etc.) for a location. The service provider would determine if the telephone was set to privacy mode, and if so, return an error message 12. If the telephone was not in privacy mode and could be located 8, a position (usually in longitude and latitude) would be returned 9. In addition a computed 16 access charge 14 could be billed back to the service bureau. The service bureau could then compute a relational position for the telephone (in central park for example) from the returned position 10. The relational location (and/or longitude and latitude if desired) could then be returned to the consumer 11 and the consumer could be billed for the service 15 after a service charge had been computed 17. In addition, and error message 13 could be returned to the consumer if the telephone was in privacy mode or could not be located in the system (shut off, etc.).

It should be remembered that the universal locator service can be owned an operated by one of the mobile telephone service providers, or that the service providers could team together to provide the service as well as totally independent locator services. In other words, it is possible that the combination of systems could be a complete or partial round-robin between the service providers themselves, or alternatively it could contain outside, non-service provider players.

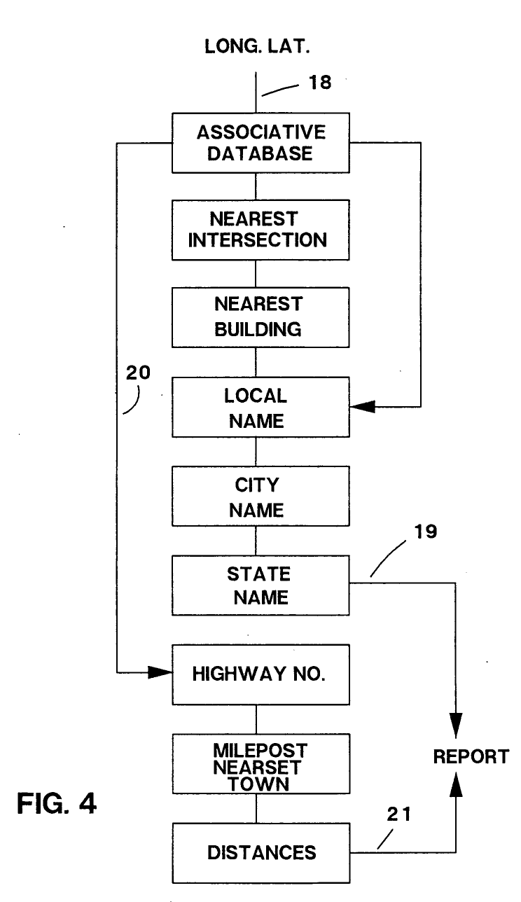

The general process employed by the present invention to convert a positional fix into a relational form can be seen in FIG. 4. FIG. 4 is merely illustrative of one of many ways to do this. In this case, longitude and latitude 18 of the mobile telephone is used to search an associative database. The associative database can be searched for both urban and rural settings. In an urban situation, it might be desirable to find the nearest intersection (Wacker Dr. and Monroe St.), or the nearest building (the Sears Tower), or a local name (Central Park), as well as a city name (Chicago, New York) and state, etc. A jump could be made directly to a local name without looking for intersections or buildings. In a rural setting 20 a jump could be made to find the nearest highway, milepost or distance from some known town or object (such as milepost 50 Interstate 88, or 5 miles west of Millville, Ohio on Interstate 80). In any case, a report 19, 21 would be formulated in a form that a consumer could understand (“The location of the requested telephone is 15 miles west of Hanford Wis. on Interstate 94 and moving south at 55 miles per hour”). The response 19, 21 could be returned by a human operator or a synthesized voice or on a computer screen in the form of text or in any other human understandable form.

It can be seen that the great utility of the present invention is the ability for anyone concerned to locate any mobile telephone subject to total or partial privacy constraints.

It should be understood that several descriptions and illustrations have been provided to aid in the understanding of the present invention. The present invention is not limited to these descriptions and illustrations. Many changes and variations are possible that reflect the sprit and are within the scope of the present invention.

I claim:

1. A telephone location system comprising:
an assisted GPS telephone handset;
a telephone service provider providing assisted GPS telephone location services in communication with said handset;
a consumer location service facility accepting a request from a consumer to locate a particular cellular handset, said consumer location service facility cooperating with said telephone service provider to determine a telephone handset location of said particular telephone handset, said consumer location service facility then communicating said telephone handset location to said consumer.

2. The telephone location method and service of claim 1 wherein said telephone handset location is returned to said consumer by verbal description.

3. The telephone location method and service of claim 1 wherein said telephone handset location is supplied to said consumer by means of a map.

4. The telephone location method and service of claim 1 wherein said consumer location facility communicates with said consumer by internet.

5. The telephone location method and service of claim 1 wherein said consumer location facility returns a longitude and latitude to said consumer.

6. The telephone location method and service of claim 1 wherein said telephone handset location is blocked by an action of an owner of said telephone handset.

7. A method for providing consumers a telephone handset location comprising:
requesting a telephone handset location from a consumer service facility; said consumer service facility
requesting an assisted GPS service provider for a location of said handset; said assisted GPS service provider
determining the location of said handset, said assisted GPS service provider
communicating the location of said handset to said consumer service facility;
receiving by the consumer the location of said handset from said consumer service facility.

8. The method of claim 7 further comprising blocking said request when a handset owner has requested privacy.

9. The method of claim 7 wherein said request is via the internet.

10. A consumer service that provides locations of mobile telephones on demand from consumers for a fee, said consumer service comprising a means for communicating a consumer request for location of a mobile telephone to a mobile telephone service provider; a means for receiving back from said mobile telephone service provider a position of said mobile telephone; a means for converting said position to a relational position; means for providing said relation position of said mobile telephone to a consumer.

11. The consumer service of claim 10 wherein said mobile telephone service provider blocks said request for location.

12. The consumer service of claim 10 wherein said mobile telephone service provider uses assisted GPS to determine said longitude and latitude of said mobile telephone.

13. A method providing consumers with the current location of a cellular telephone where a consumer service bureau communicates with a plurality of mobile service providers comprising the steps of:
a consumer requesting from the consumer service bureau a current location of a particular mobile telephone by providing a telephone number of the mobile telephone to the consumer service bureau, whereby the consumer agrees to pay a first predetermined fee to the consumer service bureau for this service;
the consumer service bureau determining which mobile telephone provider owns the telephone number provided by the consumer;
the consumer service bureau requesting from the determined mobile telephone provider the location of the particular mobile telephone, whereby the consumer service bureau agrees to pay a second predetermined fee for this service to the mobile telephone provider;
the mobile telephone provider placing a location request into its telephone system to locate the particular mobile telephone;
the mobile telephone provider returning a position of the particular mobile telephone to the consumer service bureau;
the consumer service bureau translating the returned position of the particular mobile telephone to a relational format if not in relational format;
the consumer service bureau returning the position of the particular mobile telephone to the consumer in relational format or longitude and latitude.

14. The method of claim 13 further comprising the step of the mobile service provider returning an error message to the consumer service bureau if the particular mobile telephone cannot be located or is in privacy mode.

15. The method of claim 14 wherein said privacy mode is partial and is controlled by an identification means to allow location access to parties presenting the identification means.

16. The method of claim 15 wherein said identification means is a PIN number.

17. A telephone location system comprising a plurality of mobile service telephone providers pooling location services wherein a consumer could request at least one of said providers to locate a particular mobile telephone and said provide could communicate with any other of said providers to locate said mobile telephone and return a location of the telephone to said consumer.

18. The telephone location system of claim 17 wherein at least one of said service providers charges said consumer a fee for said return of said location.

19. The telephone location system of claim 17 wherein one of said service providers charges another of said service providers an access fee for said return of said location.
